(19) United States
(12) Patent Application Publication
(10) Pub. No.: US 2015/0173998 A1
(43) Pub. Date: Jun. 25, 2015

(54) DEVICE FOR MASSAGING AND FOR APPLYING A COSMETIC COMPOSITION

(71) Applicant: L'OREAL, Paris (FR)

(72) Inventors: Laure Thiebaut, Clichy (FR); Soraya Kadra, Asnieres Sur Seine (FR)

(21) Appl. No.: 14/413,681

(22) PCT Filed: Jul. 5, 2013
(86) PCT No.: PCT/EP2013/064280

§ 371 Date: Jan. 8, 2015

Related U.S. Application Data
(60) Provisional application No. 61/681,772, filed on Aug. 10, 2012.

(30) Foreign Application Priority Data
Jul. 9, 2012 (FR) 1256598

(51) Int. Cl. A61H 7/00

(52) U.S. Cl. CPC A61H 7/003; A61H 2201/1671

(57) ABSTRACT

The present invention relates to a cosmetic device (1) comprising:—an end-piece (5) comprising a base (2) and elements (4) upstanding from the base (2), the upstanding elements (4) defining at least two distinct groups (10, 11),—a body (3) configured to receive the end-piece (5),—a means for rotating the end-piece (5) about an axis (X) relative to the body (3), in which the groups of upstanding elements have cross sections that are not included in one another at the zone of attachment to the base, and at least one of the upstanding elements is made of elastomer.

The subject of the present invention is a device for massaging and applying a cosmetic composition, including a care composition, to a body surface, especially the body or the face.

In particular, this end-piece is particularly advantageous in the field of massaging certain zones of the body and of cleansing the skin, and in particular in deep cleansing for removing impurities from the pores of the skin. It may also be useful in applications for cleansing or for care of the body.

The expression “cosmetic product” is understood to mean a product as defined in Council Directive 93/35/EEC of 14 Jun. 1993.

The application of a cosmetic composition with the aid of an assembly comprising an aerosol container and a device to be mounted on the aerosol container, comprising a rotating massaging member driven by an electric motor, is known from EP 1 728 494.

The invention aims to provide novel ways of massaging and applying certain cosmetic active agents.

Document FR 2 918 545 discloses an assembly for dispensing and applying a cosmetic composition, comprising:
a receptacle containing a cosmetic composition,
an end-piece,
an application device comprising:
   a body configured to receive the receptacle and the end-piece,
   a means for rotating the end-piece relative to the body, and
   a duct for conveying the composition from the receptacle towards an application surface of the applicator.

According to the teaching in this document, the rotation can make it possible to carry out at least one of a massaging action, a skin exfoliation action, and a composition spreading action, which can generate new sensations on application and can improve the effect of one or more active agents of the cosmetic composition.

Also according to this document, it is provided for the end-piece to have massaging reliefs, for example spikes or balls. However, no advantage connected to a particular relief of the end-piece is demonstrated.

Document U.S. Pat. No. 7,469,703 describes a bristled end-piece in the form of a symmetrical dome to be mounted on the body of a body massaging device. On account of this dome shape, the greatest pressure exerted by the end-piece is located in the center of the end-piece during the rotation of the latter. Furthermore, when the end-piece is kept still with respect to a body surface, the pressure exerted by the bristles on a point of this surface is always the same. There is no periodic modification in the contact pressure at a given point during the rotation of the end-piece.

End-pieces formed by portions that are included in one another also exist, each portion comprising upstanding elements having different natures or shapes. When such end-pieces are positioned on top of the surface to be treated, the rotation of the end-piece does not produce the same effects at every point on the surface to be treated.

The drawback with such an end-piece is also that not every point on the surface to be treated benefits from each portion comprising upstanding elements having different natures or shapes.

The problem addressed by the invention is that of providing a rotating device in which the end-piece is capable:
of producing different effects, in particular cleansing and massaging,
wherein the treatment should be identical on every selected zone of the body.

Within the scope of massaging the body or face, end-pieces that provide an improved sensation of well-being while improving blood circulation or lymphatic circulation, so as to produce a decongestant effect, for example in the region of the contour of the eyes, are desired.

Within the scope of cleansing or care of the face, massaging end-pieces which are soft but nevertheless effective for obtaining clean skin, without imperfections, having a uniform complexion and without redness, are desired. To this end, the objective of cleansing the face, in particular for greasy skin or skin prone to acne, is to avoid the proliferation of bacteria, such as P. acnes, in the pores of the skin. For what is known as normal to dry skin, the main objective of cleansing the face is to remove dead skin.

There also exists a need to provide low cost massaging end-pieces, in order that they can be attached to any device for packaging a cosmetic composition, in particular when these devices contain active agents for cleansing the face.

There also exists a need for a massaging end-piece, the operation of which enables different levels of cleansing of the skin.

There also exists a need for a massaging end-piece suited to the hollows and reliefs of a face, in order to enable the cheekbones to be cleansed as well as the sides of the nose.

Encouraging the product to foam makes a contribution to effective deep cleansing since it makes it easier for the massaging end-piece to slide over the entire surface of the skin.

There also exists a need for a massaging end-piece which provides new types of sensoriality while correctly applying the cosmetic products or while deep cleansing, and which massages in order to boost blood circulation and lymphatic circulation.

The object of the invention is to solve all or some of the problems identified above by proposing a rotating applicator comprising an end-piece composed of different materials or different application elements, so as to alternate, during the rotation, the action of the various elements on the skin of the user.

The subject of the invention is a cosmetic device comprising:
an end-piece comprising a base and elements upstanding from this base, the upstanding elements defining at least two distinct groups of upstanding elements,
a body configured to receive the end-piece,
a means for rotating the end-piece about an axis (X) relative to the body, in which the groups of upstanding elements have cross sections that are not included in one another at the zone of attachment to the base,
and at least one upstanding element (4) is made of elastomer, and
   at the zone of attachment to the base, the upstanding elements made of elastomer occupy more than 20% of the total surface area of the base.

This proportion of the elements made of elastomer ensures flexibility of the device and also pleasant contact with the skin. The device is easier to use. It closely follows the surface of the body.

Advantageously, at the zone of attachment to the base, the upstanding elements made of elastomer occupy between 30% and 90% of the total surface area of the base.

More advantageously, at the zone of attachment to the base, the upstanding elements made of elastomer occupy between 40% and 80% of the total surface area of the base.

With the device according to the invention, it is now possible to alternate the nature of the upstanding elements on the skin during the rotation of the end-piece, in order to apply alternating soft-surface and rough-surface cleansing while massaging the zone treated and boosting the circulation. For example, it becomes possible to alternate the application of different pressure levels so as to achieve improved relaxation. With regard to the alternation of elements having different natures, this can make it possible to achieve gentle peeling accompanying the cleansing.

The invention also relates to a cosmetic method comprising the use of the above device.

According to the invention, the upstanding elements are each terminated by a free end. This end comes into contact with the surface to be treated during the use of the device, in particular into contact with the skin.

Advantageously, the upstanding elements are massaging and application elements.

Within the meaning of the present invention, “the groups of upstanding elements have cross sections that are not included in one another” is understood to mean if the cross sections are disjointed, not included in one another, separated or not contained in one another or isolated.

According to the invention, “mid-plane” is understood to mean a plane perpendicular to the base passing through the axis (X) of rotation of the brush.

The invention also relates to a kit comprising the above device.

The invention also relates to an end-piece as defined above.

With at least two types of upstanding elements on the surface of the base, synergy is created between the elements, thus contributing towards better cleansing of the skin than that obtained by cleansing end-pieces that comprise only one type of upstanding elements. The advantage provided by the upstanding elements of the second group is that they provide for example an effective contact surface with the skin which is much larger than the effective contact surface provided by the elements of the first group.

Advantageously, each group comprises at least three, and preferably at least five, upstanding elements. Specifically, the more upstanding elements there are, the more the synergy can be observed.

For example, the elements of one and the same group are implanted over a surface that has an area smaller than or equal to that of a surface from which the elements of the other of the two groups are implanted. In particular, the implantation surface of the elements of the second group is larger than that of the elements of the first group. The implantation density of elements on each of these surfaces may be variable from one surface to the other. Similarly, the average distance found between adjacent elements on one and the same surface may be different from that found on the other of the surfaces.

According to the invention, the massaging end-piece may have two unique surfaces. However, as an alternative, it may also have more than two distinct surfaces.

According to the invention, each point on the treated surface of the body can benefit from the effect of each type of upstanding element.

Advantageously, the groups of upstanding elements define distinct angular portions. This disposition ensures an efficacious effect of each group on the surface treated.

According to one embodiment of the device of the invention, the end-piece comprises more than three groups of upstanding elements and at least two groups are identical and not adjacent. With such a distribution of the groups, it is possible to increase the efficacy of one particular group, by way of a repetition effect.

Advantageously, the groups define sections with identical surface areas, at the zone of attachment to the base. Thus, the distribution of sections is identical and the period of action thereof on the surface treated is the same.

More advantageously, the end-piece is partly bristled.

In one particular embodiment, the end-piece has no mid-plane of symmetry passing through the axis (X).

Preferably, the surface area of the base is greater than 3 cm² and preferably greater than 5 cm². This dimension is specifically suitable for the contours of the face. The surface area is preferably less than 150 cm². Between 30 cm² and 150 cm², the dimension is suitable for the contours of the body (thighs, buttocks, stomach, back, etc.).

More preferably, the distinct upstanding elements differ from one another in their shape and/or the material of which they are made.

Thermoplastic Material

“Thermoplastic material” is understood to mean any thermoplastic material, for example SEBS, a silicone, latex, a natural rubber, a material having improved slip, butyl, EPDM, a nitrile, a thermoplastic elastomer “TPE”, a polyester elastomer, a polyamide elastomer, a polyethylene elastomer or a vinyl elastomer, a polyolefin such as PE or PP, in particular low density PE, PVC, EVA, PS, SIS, PET, POM, PU, SAM, PA or PMMA. Such materials have rapid drying characteristics when they are wetted on the surface, on account in particular of suitable surface tension characteristics. It is possible in particular to use the materials known under the trade names Teflon®, Hytrel®, Cariflex®, Alixine®, Santoprene®, Pebax® and Pollobas®. The material used to produce the upstanding element may contain a softening agent and/or a bactericidal agent, such as silver ions, for example.

Massaging and Application Devices

When the end-piece is rotated by the means for rotating, the speed of rotation of the end-piece may be for example between 100 and 400 rpm, preferably between 200 and 300.

The end-piece may be rotated about a geometric rotation axis which is fixed relative to the body. As a variant, the end-piece may be rotated about a geometric rotation axis which is able to move relative to the body. If necessary, the movement of the end-piece may be an eccentric movement, and this can make it possible to spread the composition more regularly and with a less pronounced border between the treated region and the untreated region, this possibly being advantageous for a self-tanner for example.

The end-piece may be rotated about a geometric rotation axis which forms a zero angle or non-zero angle with the longitudinal axis of the receptacle. A non-zero angle may improve ergonomics.

The direction of rotation may be clockwise or counterclockwise.

The end-piece may be mounted removably on the massaging and application device, and this can make it possible to separate it from the application device in order to clean it and/or to replace it with another end-piece selected depending on the treatment to be carried out or else to throw it away after it has become worn.

Material Forming the Upstanding Elements

The upstanding element may comprise a cellular material which may be elastically deformable and/or compressible. This material may be a foam. The foam may be produced from a material selected from the following list: Polyurethane, polyether, polyester, polyvinyl chloride, polyethylene, EVA, latex, silicone, SIS, SEBS, silicone elastomer, latex elastomer, nitrile elastomer, butyl elastomer, Neoprene®, NBR, SBR, this list not being limiting.

The upstanding element may have a composite structure having a plurality of layers having different natures, for example a number of types of foam.

The upstanding element may have any shape. It may have a circular, oval or polygonal cross section, for example a triangular, square, hexagonal, etc. cross section.

The upstanding element may have abrasive properties. “Abrasive property” should be understood as meaning a surface which, when moved over the skin, removes at least some of the dead cells from the surface.

Such surfaces can be characterized by an abrasive power of between 0.01 and 0.03 g/cm²/min. The abrasive power corresponds to the quantity of plaster removed per minute, per square centimetre of an abrasive surface applied to a square of plaster having a thickness of 50 mm using a 135W Black and Decker CD 400 sander, the pressure exerted on the square of plaster resulting from the weight of the sander, only the movement of which in the plane of the abrasive surface is constrained.

Such upstanding elements are obtained either by taking a substantially rigid cellular material, or by incorporating hard grains into a flexible cellular material.

An example of an abrasive surface is a nonwoven exfoliating pad sold by 3M.

The foam may be a soft and flexible foam particularly suitable for spreading the product, sometimes also known as a sponge.

The upstanding element may be for example a hydrophilic crosslinked polyester foam, for example having a density equal to 32 kg/m³.

A sponge traditionally used for applying foundation, such as NBR, for example Yukilon® from Penthouse Group is also conceivable.

The upstanding element may be a thermocompressed foam. Thermocompression makes it possible to create reliefs on the surface of the foam and/or to complex it with an elastic fabric, thereby making it possible to have the flexibility of the foam but the feel of a textile more pleasant than that of plastic.

An example of a thermocompressed foam is a closed-cell foam made of polyolefin, for example thermocompressed polyethylene having a specific weight of 33 kg/m³, which is for example complexed with an elastic fabric such as for example Lycra®.

The upstanding element may be a file made of plastics material, metal or glass.

The upstanding element may be made of injection-molded flexible plastics material, for example of elastomer, and have massaging reliefs, for example spikes having pointed ends, rounded ends, a round, square, or triangular cross section, a length of between 1 mm and 40 mm for example, or balls having a round or oval cross section and a height of between 1 mm and 20 mm for example.

The upstanding element is for example made of an elastomer such as SEBS or silicone.

The upstanding element may be a brush made of synthetic or natural bristles, for example a bristled brush having tufts of strands of polyamide or PBT for example having a diameter of between 0.05 and 0.2 mm and more particularly made of Nylon® 6.12 having a diameter of 0.075 mm, which have been milled and ground in order to make them very soft in contact with the skin.

Shape of the Upstanding Elements

Each upstanding element has a cross section, defined at a zone of attachment to the base, which has in particular a circular, oval, square, polygonal, triangular, ovoid or star-shaped shape.

The cross section, defined at a zone of attachment to the base, may also extend along a curve. For example, this curve may be characterized by an average radius of curvature which is, for example, at least greater than 30 mm and better still at least greater than 45 mm. The curved shape gives the upstanding element a certain rigidity, especially when the thickness is small.

The cross sections of the upstanding elements, which are defined at a zone of attachment to the base, may extend along lines which each have a concavity facing towards the center of the surface from which the elements are upstanding.

Different levels of cleansing can thus be achieved by simply modifying the way in which the end-piece is held, while preserving the same hand movements in relation to the skin. Specifically, this simple manipulation will bring about positioning of the massaging elements, and in particular those of the second group, which is completely different in relation to the skin. By means of a back-and-forth hand movement over the skin, the simple reorientation of the elements of the second group in relation to the skin can provide a different type of cleansing.

Advantageously, in order to make it easier for the upstanding elements to be deployed, the latter may have a cross section that decreases in size between the cross section at the zone of attachment and their free end. Thus, the upstanding elements are more flexible at their free end than at their base.

Implantation of the Upstanding Elements

The “end of the upstanding element” is understood to mean the point of the upstanding element which is farthest from the base and located on their main extension axis starting from their zone of attachment to the base in the direction of their free end.

The “height of the upstanding element” is understood to mean the distance measured along their main extension axis in the direction of their free end. Preferably, the height of the upstanding elements is between 1 mm and 3 cm.

The “thickness of the upstanding element” is understood to mean the maximum cross section of the upstanding element measured at their zone of attachment to the base. Preferably, the thickness of the upstanding elements is between 0.1 mm and 0.5 cm.

Advantageously, the device comprises upstanding elements such that the difference in height between two elements of extreme size is less than 1.5 cm, preferably less than 1 cm, and more preferably equal to 0. This difference makes possible the efficacious alternation on the skin of the highest elements and the relaxation of the shortest elements.

“The two elements of extreme size” are understood to be the element on the base having a maximum height and the element on the base having a minimum height.

According to a particular embodiment, the applicator may comprise an implantation of upstanding elements having axial symmetry about an axis at right angles to the base. It thus makes no difference if the user decides to operate the massaging end-piece with his left hand or his right hand or if the direction of rotation is clockwise or counterclockwise.

For example, the surface of the base from which the elements are upstanding is planar. In this case, the cross section of the elements in their zone of attachment to the base corresponds to the section produced on the plane of the surface of the base.

In order to be more particularly suited to the reliefs found on the surface of the face or of the body, a surface passing through the free ends of each of the upstanding elements defines a concavity.

The invention also relates to an assembly comprising a cosmetic receptacle comprising a through-hole in which an end-piece as defined above is housed.

In particular, this receptacle may be a tube or a bottle.

The invention may be better understood on reading the following description of non-limiting implementation examples thereof, and with reference to the attached drawing, in which:

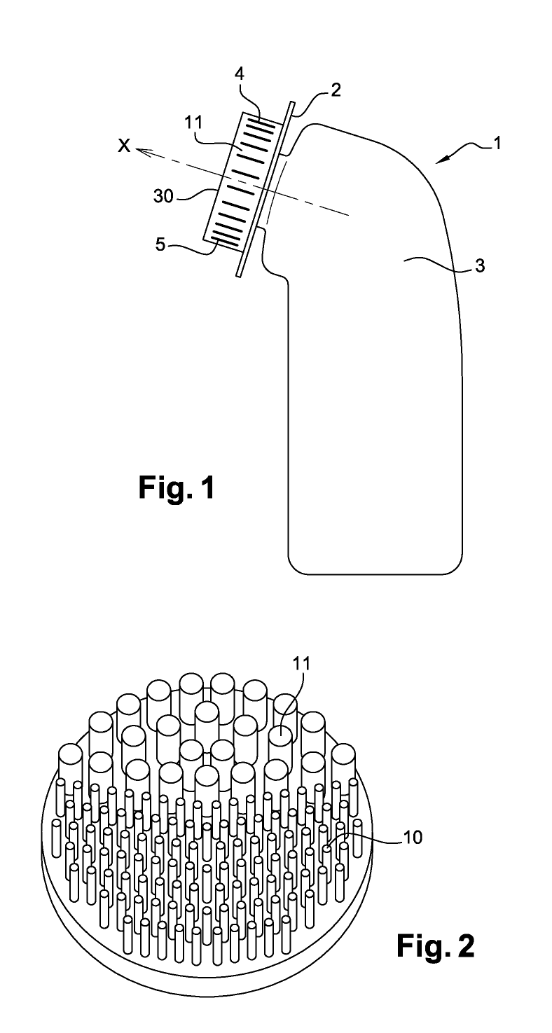

FIG. 1 schematically shows a front view of an example of a device according to the invention,

FIG. 2 is a schematic perspective view of an end-piece according to the invention,

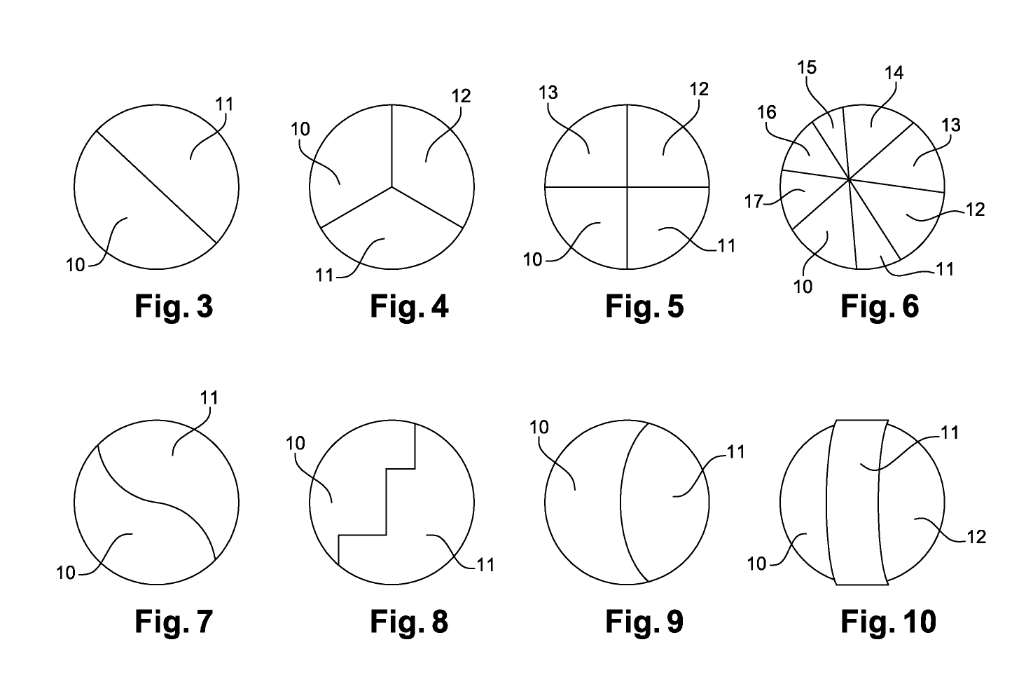

FIGS. 3 to 10 show cross sections, defined at a zone of attachment to the base, through end-pieces according to the invention.

FIG. 1 shows a device 1 produced in accordance with the invention.

This device 1 comprises a body 3 on which there may be mounted an end-piece 5 defining an application surface intended to come into contact with the skin.

The device 1 is for example produced in accordance with patent application US 2006/0276731.

The body 3 may house means for rotating the end-piece 5 in a rotational movement relative to the body 3.

This movement is for example a rotational movement about a rotation axis X which is fixed relative to the body 3.

The means for rotating may comprise an electric motor which is housed in the body 3, is supplied by one or more batteries, and rotates the end-piece about the axis X by way of gears.

The power may also be supplied by a battery or rechargeable battery.

In the example illustrated in FIG. 1, the end-piece 5 comprises upstanding elements 4 defining the application surface 30. The upstanding elements are fixed to a base 2 and are terminated by their free end 11.

In the example in FIG. 2, the end-piece is in accordance with the invention. The end-piece comprises two portions 10 and 11, each composed of tufts of bristles. The tufts in the portion 10 comprise more bristles than there are in the portion 11. Therefore, the tufts of bristles in the two portions are different. They form two angular sections having more or less identical dimensions.

The elements of which the region 10 is composed could also be selected from the following list:
Bristled fibers (nylon etc.),
Spikes of elastomer having various shapes,
Rigid spikes having various shapes: balls, waves or various massaging shapes made of elastomer,
Sponge or some other porous material.

The elements of which the region 11 is composed could also be selected from the following list:
Bristled fibers (nylon etc.) Spikes of elastomer having various shapes,
Rigid spikes having various shapes,
Balls, waves or various massaging shapes made of elastomer,
Balls, waves or various massaging shapes made of rigid material (plastics material, glass, metal, ceramic, etc.),
Sponge, foam or some other porous material.

According to the invention, the elastomer is in particular a thermoplastic elastomer “TPE”, a polyester elastomer, a polyamide elastomer, a polyethylene elastomer or a vinyl elastomer.

FIGS. 3 to 10 show cross sections through elements at the zone of attachment to the base.

These figures show the groups of upstanding elements 10, 11, 12, 13, 14, 15, 16. These groups are distinct and not included in one another. They form simple angular portions (FIGS. 3 to 6) or complex angular portions (FIGS. 7 to 9). FIG. 10 shows two portions 10 and 12 separated by the strip 11.

In order to use the device according to the invention, it is possible for example to apply a composition without the end-piece being rotated, and this can make it possible for example to spread the composition over the region to be treated. The end-piece is then rotated in order to massage the region to which the composition has been applied.

In another example, the end-piece is rotated in order to massage the region to be treated, without a composition being dispensed.

In yet another example, the end-piece is rotated in order to massage the region to be treated, without a composition being dispensed for a first time.

The massaging action may result in local heating on account of the friction of the end-piece on the skin for example, and the absence of the composition on the end-piece initially may increase the friction and the sensation of heat that results therefrom.

Next, while the end-piece is still being rotated or, as a variant, while the end-piece is at a standstill, the composition may be dispensed and spread over the region previously massaged.

In the entire description, the expression “comprising a” should be considered as being synonymous with “comprising at least one”, unless specified to the contrary.

1.-12. (canceled)

13. A cosmetic device comprising:
an end-piece comprising a base and elements upstanding from the base, the upstanding elements defining at least two distinct groups;
a body configured to receive the end-piece; and
a means for rotating the end-piece about an axis relative to the body,
wherein the at least two distinct groups of upstanding elements have cross sections that are not included in one another at a zone of attachment to the base, and at least one of the upstanding elements comprises at least one elastomer, and
wherein at the zone of attachment to the base, the at least one upstanding element comprises greater than about 20% of the total surface area of the base.

14. The device according to claim 13, wherein the at least two distinct groups of upstanding elements define distinct angular portions.

15. The device according to claim 13, wherein the end-piece comprises between two and eight groups of upstanding elements.

16. The device according to claim 13, wherein the end-piece comprises more than three groups of upstanding elements and at least two groups are identical and not adjacent.

17. The device according to claim 13, wherein the at least two distinct groups define sections with identical surface areas, at the zone of attachment to the base.

18. The device according to claim 13, wherein the end-piece is partly bristled.

19. The device according to claim 13, wherein the end-piece has substantially no mid-plane of symmetry passing through the axis.

20. The device according to claim 13, wherein the at least two distinct groups of upstanding elements differ from one another in at least one of the shape and the material of which they are made.

21. The device according to claim 13, wherein the total surface area of the base is greater than about 3 cm².

22. The device according to claim 13, wherein the end-piece comprises between two and four groups of upstanding elements.

23. The device according to claim 13, wherein the total surface area of the base is greater than about 5 cm².

24. A method of massaging a portion of the body, cleansing and/or caring for the skin, and/or application of a cleansing and/or care product to the body and/or skin, said method comprising massaging said portion of the body, cleansing and/or caring for the skin, and/or application of a cleansing and/or care product to the body and/or skin with a cosmetic device comprising:
an end-piece comprising a base and elements upstanding from the base, the upstanding elements defining at least two distinct groups;
a body configured to receive the end-piece; and
a means for rotating the end-piece about an axis relative to the body,
wherein the at least two distinct groups of upstanding elements have cross sections that are not included in one another at a zone of attachment to the base, and at least one of the upstanding elements comprises at least one elastomer, and
wherein at the zone of attachment to the base, the at least one upstanding element comprises greater than about 20% of the total surface area of the base.

25. A kit comprising a cosmetic device, the cosmetic device comprising:
an end-piece comprising a base and elements upstanding from the base, the upstanding elements defining at least two distinct groups;
a body configured to receive the end-piece; and
a means for rotating the end-piece about an axis relative to the body,
wherein the at least two distinct groups of upstanding elements have cross sections that are not included in one another at a zone of attachment to the base, and at least one of the upstanding elements comprises at least one elastomer, and
wherein at the zone of attachment to the base, the at least one upstanding element comprises greater than about 20% of the total surface area of the base.

26. An assembly comprising:
a cosmetic receptacle including a through-hole in which an end-piece is housed, the end-piece comprising:
a base and elements upstanding from the base, the upstanding elements defining at least two distinct groups,
wherein the end-piece is configured to be received by a body,
wherein the end-piece is configured to rotate about an axis relative to the body,
wherein the at least two distinct groups of upstanding elements have cross sections that are not included in one another at a zone of attachment to the base, and at least one of the upstanding elements comprises at least one elastomer, and
wherein at the zone of attachment to the base, the at least one upstanding element comprises greater than about 20% of the total surface area of the base.
